(19) United States
(12) Patent Application Publication
(10) Pub. No.: US 2012/0275442 A1
(43) Pub. Date: Nov. 1, 2012

(54) DYNAMIC PROVISIONING OF MOBILE DEVICE PROFILES IN A ROAMING NETWORK

(75) Inventors: Konstantin Malets, Saint-Petersburg (RU); Dmitry Demyanchik, Saint-Petersburg (RU); Ivanov Oleg Anatolyevich, Saint-Petersburg (RU)

(73) Assignee: RAWLLIN INTERNATIONAL INC., Tortola (VG)

(21) Appl. No.: 13/094,032

(22) Filed: Apr. 26, 2011

(51) Int. Cl. H04W 4/16

(52) U.S. Cl. 370/338; 455/417

(57) ABSTRACT

Systems and methods for cost-effective phone calls and dynamic provisioning of mobile profiles within a roaming environment are presented herein. A platform component stores multiple profiles for a mobile device and can dynamically reroute incoming phone calls to another profile using a database of stored profiles and a rerouting component. The phone call is rerouted from a first identity of a mobile device that is associated with a first network, to a second identity that corresponds to the second network that the mobile device is roaming in enables the mobile subscribers to bypass the high charges associated with roaming. Furthermore, a roaming platform component can perform location updates on a mobile device, thereby updating the identity of the mobile device's SIM card to ensure that the mobile device has an identity profile that corresponds to a visited network in which the mobile device is roaming.

### TECHNICAL FIELD

This disclosure relates generally to mobile communications in connection with roaming, such as roaming across operator networks, or international roaming.

### BACKGROUND

Roaming agreements between network operators allow cellular phones to leave their home networks and be used in networks run by different operators, even by network operators in different countries. This has enabled owners of the cellular phones to become more mobile while retaining their connectivity for business and pleasure, without having to independently negotiate with every operator and without carrying multiple devices for the different operators. Both voice and data services can thus be used while the user of the phone is traveling within the country and abroad. Conventional roaming agreements also allow the cellular phone to be reached by dialing the same number without regard to where the cellular phone is located. This allows the user to keep the same phone number without having to update their number, or their device, whenever they travel to an area covered by a network operator other than the home network.

A disadvantage of these roaming agreements, however, is that since the phone maintains its original identity as a phone belonging to the home network, calls made to and from the roaming network often have higher costs associated with the calls than a phone call made within the home network. An existing partial solution to the high costs involved with roaming is to change the identity of the cellular phone when in a roaming network by switching the subscriber identity module (SIM) card. However, this solution is imperfect as changing the phone identity so as to have the cellular phone act like a local phone in the roaming network gives the cellular phone a new phone number, making it difficult for the subscriber's acquaintances to reach the subscriber. There is therefore a need to minimize calling costs in roaming networks while maintaining a stable and known identity.

FIG. 1 illustrates a conventional roaming environment 100 that includes Home Public Mobile Network (HPMN) 108 which is operated by the Home Public Mobile Network Operator (HPMNO) 106. The operator can include a Mobile Network Operator (MNO), a Fixed Network Operator (FNO), an Internet Service Provider (ISP), and/or an Application Service Provider (ASP).

Further, HPMN 108 can connect to other networks, including Visited Mobile Public Network (VPMN) 112, which is operated by the Visited Mobile Public Network Operator (VPMNO) 110. HPMN 108 can connect to VPMN 112 via an interface over General Packet Radio Service (GPRS), Universal Mobile Telecommunications System (UMTS), or any other Global System for Mobile Communications (GSM) standard.

Mobile device 104 operates on HPMN 108 and can make phone calls to mobile device 102 which operates on VPMN 112. Since mobile device 104 and mobile device 102 are on different networks, the users are billed for the phone call according to roaming agreement 114, which sets standards for billing arrangements between networks 108 and 112.

When mobile device 104 places a call to mobile device 102 on VPMN 112, mobile device 104 uses the same phone number that mobile device 102 has on HPMN 108. When the call gets transferred by HPMNO 106 to VPMNO 110, VPMNO 110 recognizes the call as one placed on HPMN 108, and that mobile device 102 is roaming on VPMN 112. Accordingly, conventionally, costly roaming charges are billed to both the users of mobile device 104 and mobile device 102.

The above-described deficiencies of conventional roaming environments and practices are merely intended to provide an overview of some of problems of current technology, and are not intended to be exhaustive. Other problems with the state of the art, and corresponding benefits of some of the various non-limiting embodiments described herein, may become further apparent upon review of the following detailed description.

### SUMMARY

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other advantages and distinctive features of the disclosed subject matter will become apparent from the following detailed description of the various embodiments when considered in conjunction with the drawings.

A rerouting system in wireless communication network can receive an incoming phone call that is directed towards a local phone number. The mobile device to which the number belongs however may be roaming in another network, and have another identity and phone number temporarily assigned to it that is local for the roaming network. The rerouting system will receive the incoming phone call, and using a database of stored profiles, can reroute the phone call to the mobile device's temporary identity on the roaming network. This allows the outgoing phone call from the home network and the incoming phone call received at the roaming mobile device to both be charged local rates, bypassing the expensive roaming charges.

When the incoming phone call for a mobile is received at a network, a SIM card on the mobile device can be updated with another phone number that corresponds to the local network in which the mobile device is located. Accordingly, the phone call can be rerouted to this second phone number.

In another embodiment, a system for managing mobile device profiles is presented. A database that maintains a pool of identity profiles that correspond to different networks can provide an appropriate identity for a roaming a mobile device. When a Home Location Register (HLR) obtains the location of a mobile device from the Visited Location Register (VLR) of the network that the mobile device is in, the HLR forwards that location to a roaming platform which assigns an appropriate identity profile form the database, based on the location, to the mobile device.

In an additional embodiment, there is a system and method for making Voice over IP (VoIP) calls for roaming devices. A mobile device initiates the process by requesting call management service from a mobile switching center, and then forms an unstructured supplementary service data (USSD) link. An invitation to a second mobile device is then sent to a switching platform which initiates a second USSD link with the second mobile device. Then a VoIP connection between the first mobile device and the second mobile device is established.

These and other embodiments are described in more detail below.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates a typical home network and visited network interaction.

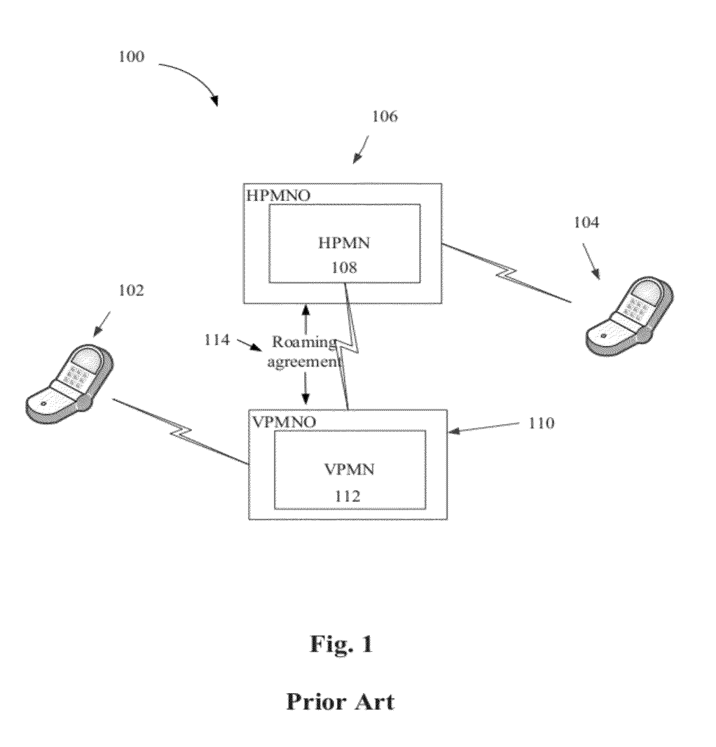

FIG. 2 illustrates a home network and visited network interaction in accordance with an embodiment.

FIG. 3 illustrates a profile assignment to a mobile device in accordance with an embodiment.

FIG. 4 illustrates a profile removal from a mobile device in accordance with an embodiment.

FIG. 5 illustrates a block diagram of a system for making a mobile terminating call in accordance with an embodiment.

FIG. 6 illustrates a block diagram of a system for making a phone call that originates from a mobile device in accordance with an embodiment.

FIG. 7 illustrates a block diagram of a system for updating the location of a mobile device in accordance with an embodiment.

FIG. 8 illustrates a flowchart process for location updating and phone call rerouting in accordance with an embodiment.

FIG. 9 illustrates a flowchart process for making VoIP calls between mobile devices according to an embodiment.

FIG. 10 illustrates a flowchart process for establishing a VoIP connection between mobile devices in accordance with an embodiment.

FIG. 11 illustrates a flowchart process for rerouting a locally originated phone call to a roaming network in accordance with an embodiment.

FIG. 12 illustrates an example of a device, a mobile handset that, can process multimedia content in accordance with the embodiments disclosed herein.

FIG. 13 illustrates a block diagram of a computer operable to execute the disclosed multi-device usage monitoring and communicating system architecture.

### DETAILED DESCRIPTION

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

As an overview of the various embodiments presented herein, to correct for the above identified deficiencies of roaming mobile devices and other drawbacks of roaming networks in general, various systems and methods described herein reduce, e.g., minimize, call costs associated with roaming by changing the identity of the mobile device to function like a local cellular phone on a roaming (visited) network, while maintaining the ability for other cellular phones to reach that phone using the phone number known on the home network.

To accomplish this, the identity of the phone is updated in roaming networks while incoming calls in the home network are dynamically rerouted to the new identity of the phone. Since these incoming calls are directed to a local number, no roaming charges are affixed, and thus all phone calls are charged at a local rate.

In another embodiment, SIM cards may come pre-provisioned with multiple identities that are dynamically switched while roaming. Similarly, SIM cards may receive new profiles from a roaming platform that stores a database of profiles that correspond to different roaming networks. The roaming platform selects an appropriate identity to transmit to the mobile device, based on the roaming network in which the mobile device is currently located.

In another aspect, voice over IP (VoIP) calls may be used to provide additional services. Since VoIP connections offer more cost-effective rates, particularly at international destinations, over traditional dedicated circuit switched voice service, and since VoIP can also provide better integration of other data services such as multimedia, context, and video than traditional circuit switched voice services, in various embodiments, roaming mobile phone calls can be rerouted via VoIP networks to provide superior services.

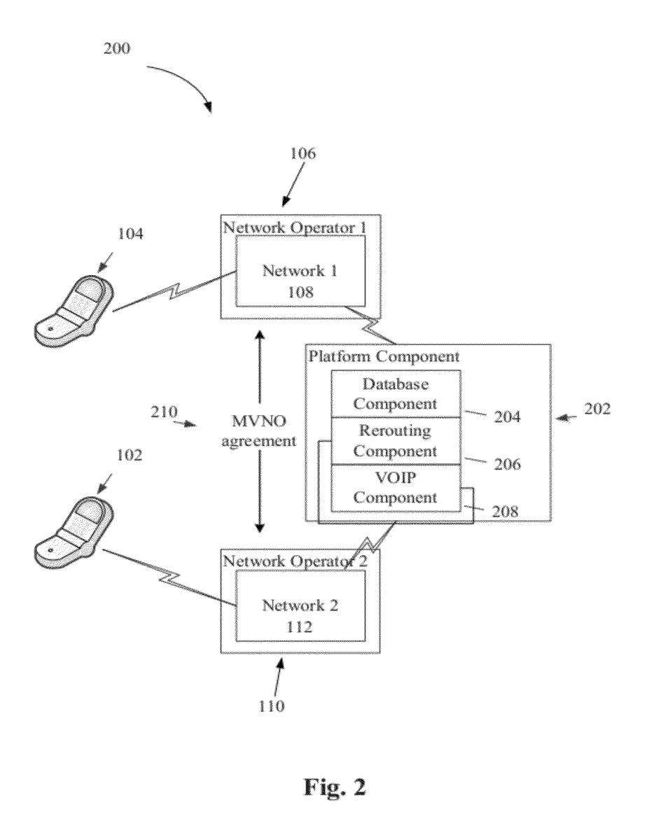

Referring now to FIG. 2, a block diagram of a home network and visited network interaction is illustrated in accordance with an embodiment. Aspects of roaming environment 200, and systems, networks, other apparatus, and processes explained herein can constitute machine-executable instructions embodied within machine(s), e.g., embodied in one or more computer readable mediums (or media) associated with one or more machines. Such instructions, when executed by the one or more machines, e.g., computer(s), computing device(s), virtual machine(s), etc. can cause the machine(s) to perform the operations described.

Additionally, the systems and processes explained herein can be embodied within hardware, such as an application specific integrated circuit (ASIC) or the like. Further, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Roaming environment 200 includes a first network 108 run by network operator 106, and a second network 112 run by network operator 110. Roaming environment 200 also includes a platform component 202 that can be a Mobile Network Operator (MNO) or a Fixed Network Operator (FNO). The first network operator 106 and second network operator 110 share a Mobile Virtual Network Operator (MVNO) agreement 210.

In one aspect, mobile device 104 can place a call to mobile device 102. The number dialed is the number that is associated with mobile device 102 when mobile device 102 is on the first network 108. Mobile device 102, however, can have a new number and identity profile, while roaming, that is associated with the second network 112. This new identity for mobile device 102 can be supplied by the platform component 202 or by the second network 112. A database component 204 on the platform component 202 stores identity profiles that correspond to mobile devices 104 and 102. When a call to mobile device 102 is received by the platform component 202 from the first network 108, the phone number of the dialed party is extracted from the Initial Address Message (IAM) of the phone call. The rerouting component 206 receives the called number and finds the matching profile of mobile device 102 in the database 204, and reroutes the phone call to that matching profile. Thus, when mobile device 104 places the call, the call is a local call directed at the first network's profile of mobile device 102. Similarly, when mobile device 102 receives the call, based on the mapping of profiles, the call is a local call that has been made to the identity profile of mobile device 102 that is native on the second network 112.

In an additional embodiment, mobile device 102 can initiate the phone call to mobile device 104 while roaming on the second network 112. The second network operator 110 forwards the call to the platform component 202, which extracts, from the IAM, the identity of the caller as well as the called party. The database component 204 has a database or other data store listing the identity of the mobile device 102 on the second network 112 and its corresponding identity profile on the first network 108. The rerouting component 206 reroutes the phone call and replaces the second network identity of mobile device 102 with its first network identity so that when mobile device 104 receives the call, the effect is as if mobile device 102 placed the call while in the first network, thereby avoiding any roaming charges.

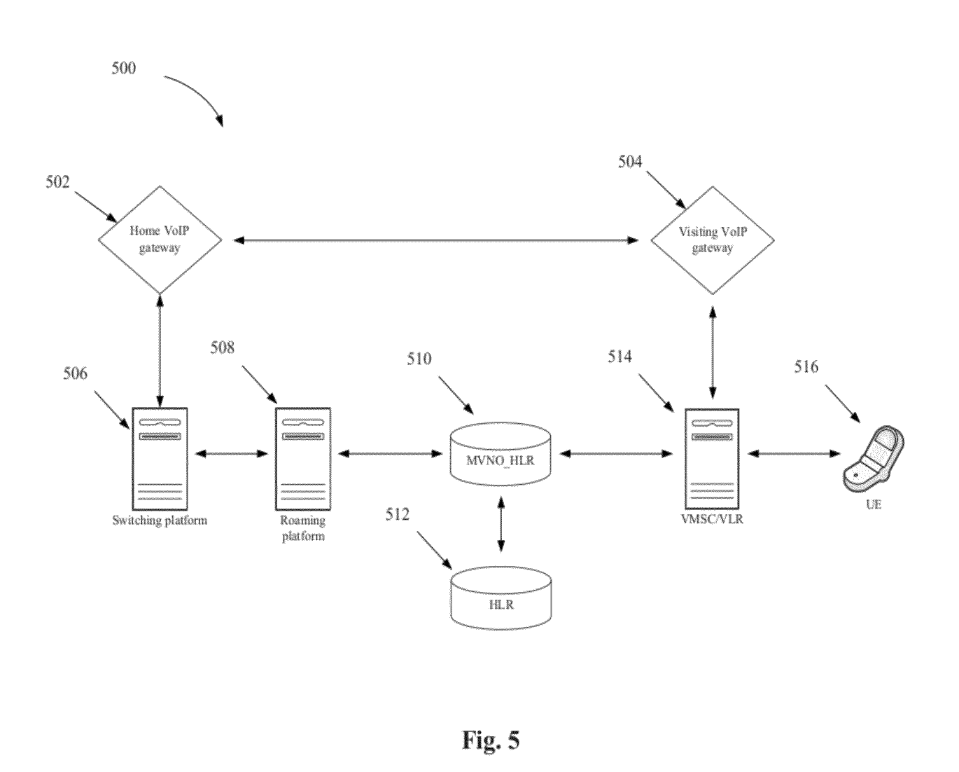

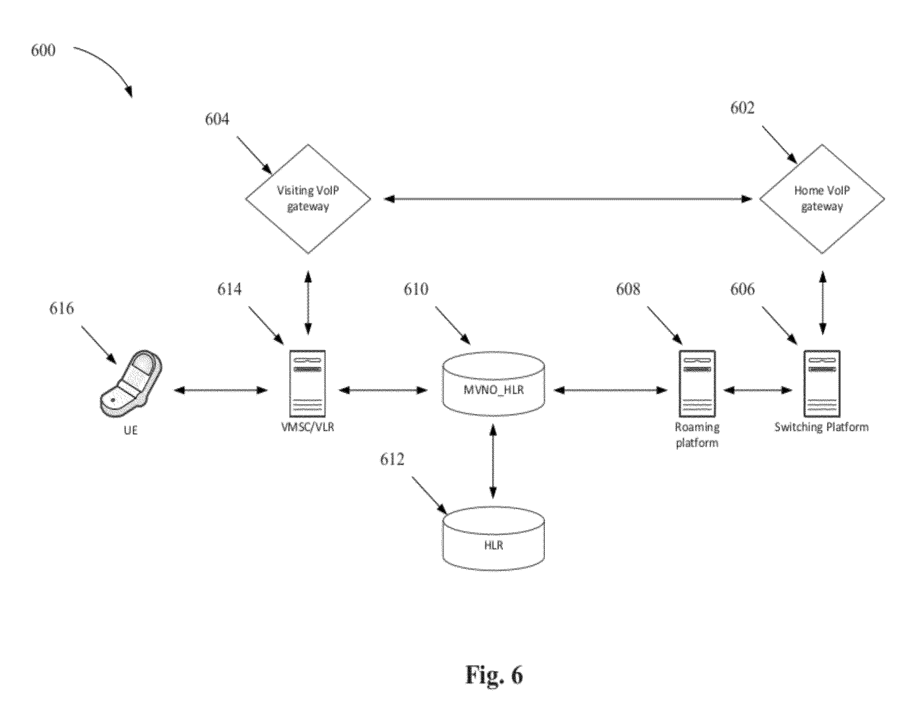

In another aspect, rerouting component 206 can forward the incoming phone call to VoIP component 208. VoIP component 208 can setup a call using existing VoIP technology over available data networks which can further lower costs. To set up a VoIP call, the VoIP component 208 connects VoIP gateways (shown in FIG. 5 and FIG. 6) located in the local networks. In this embodiment, the local devices are charged only for local calls as they are connected to their respective local VoIP gateways, thus the mobile device users can avoid the high costs associated with roaming calls.

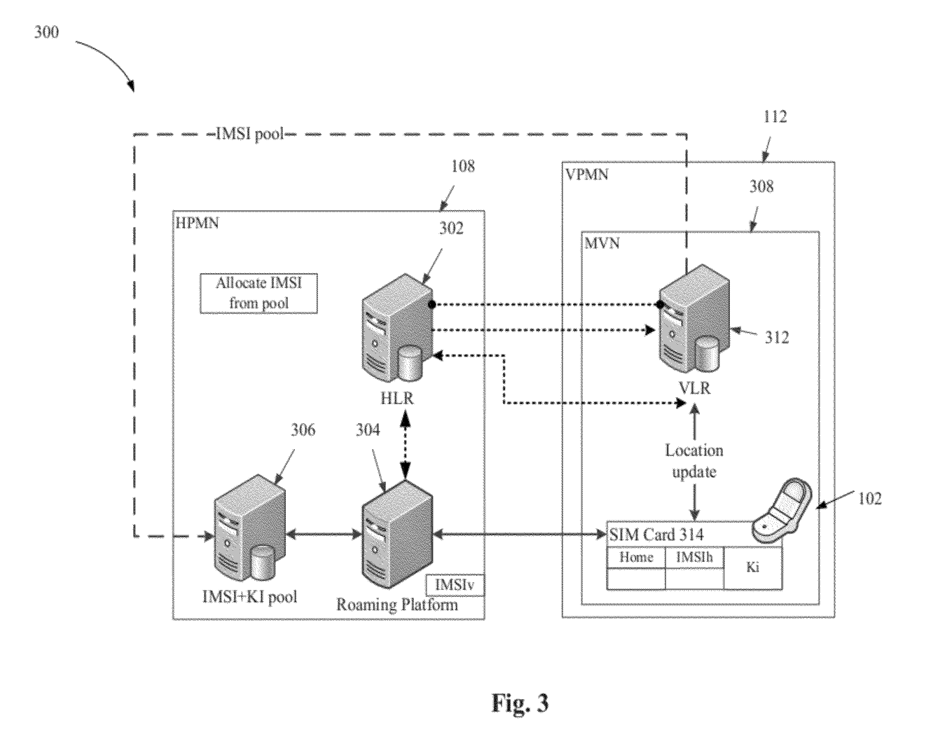

Turning now to FIG. 3, a block diagram depicting the assignment of a profile identity to a mobile device is illustrated. Roaming environment 300 contains HPMN 108 and VPMN 112. HPMN 108 can manage the profile assignment of mobile device 102 which is located in VPMN 112. Mobile device 102 contains SIM card 314 which stores the identity profiles associated with the home network 108 and the visited network 112. The SIM card 314 stores identity profiles in the form of an Individual Mobile Subscriber Identity (IMSI), which is a unique 64 bit identifier that comes associated with a Ki that is a 128 bit value used to authenticate an IMSI on a network. A Mobile Subscriber Integrated Service Digital Network (MSISDN) number can also be stored on the SIM card. An MSISDN number uniquely identifies a subscription in a GSM or UMTS mobile network. A MSISDN number can be considered equivalent to a phone number that is dialed to reach a subscriber. In Home Location Register (HLR) 302, there is a database that matches MSISDN numbers to their corresponding IMSIs.

In one aspect, SIM card 314 comes with an IMSI that corresponds to an identity profile used on the HPMN 108 as well as having a blank space for an IMSI that can be updated when the mobile device roams in VPMN 112. When mobile device 102 is activated or is found on VPMN 112, Mobile Virtual Network (MVN) 308 performs a location update, and forwards the results to HLR 302. The MVN 308 also forwards the results to the IMSI+Ki pool 306 which stores a database of IMSI and Kis for a variety of networks. IMSI+Ki pool 306, in conjunction with HLR 302, selects a IMSI identity profile that matches the VPMN 112 in which the mobile device 102 is located, and instructs the roaming platform component 304 to send mobile device 102 the new identity, which is stored in the blank profile slot on SIM card 314. The roaming platform component can also be an Over The Air (OTA) server.

In another embodiment, mobile device 102 can initiate the profile change request and send a request to the roaming platform component 304 to change profiles. Roaming platform component 304 forwards the request to HLR 302, which again forwards the request to VLR 312 and MVN 308 to perform the location update that determines in which network the mobile device 102 is located. Once the location is determined, the HLR 302 forwards the location to roaming platform component 304, which selects the appropriate IMSI identity profile to send to the mobile device 102.

Meanwhile, HLR 302 maintains a database of the MSISDN and IMSI profiles that are assigned to the mobile device 102, and when a new profile is given to the SIM card 314, the HLR 302 updates the database to ensure that it maintains the current identities associated with mobile device 102.

In an additional embodiment, SIM card 314 can come pre-provisioned with the matching IMSI and MSISDN for VPMN 112. The mobile device 102 can thus send a signal to the roaming platform component 304 to switch active profiles, which then updates the HLR 302 as to the active identity profile of SIM card 314 allowing effective rerouting to take place. The signal that the mobile device 102 sends to the roaming platform to process the profile change can be any of a wide variety of communications, including, but not limited, to Short Message Service (SMS) communications or an Unstructured Supplementary Service Data (USSD) communications.

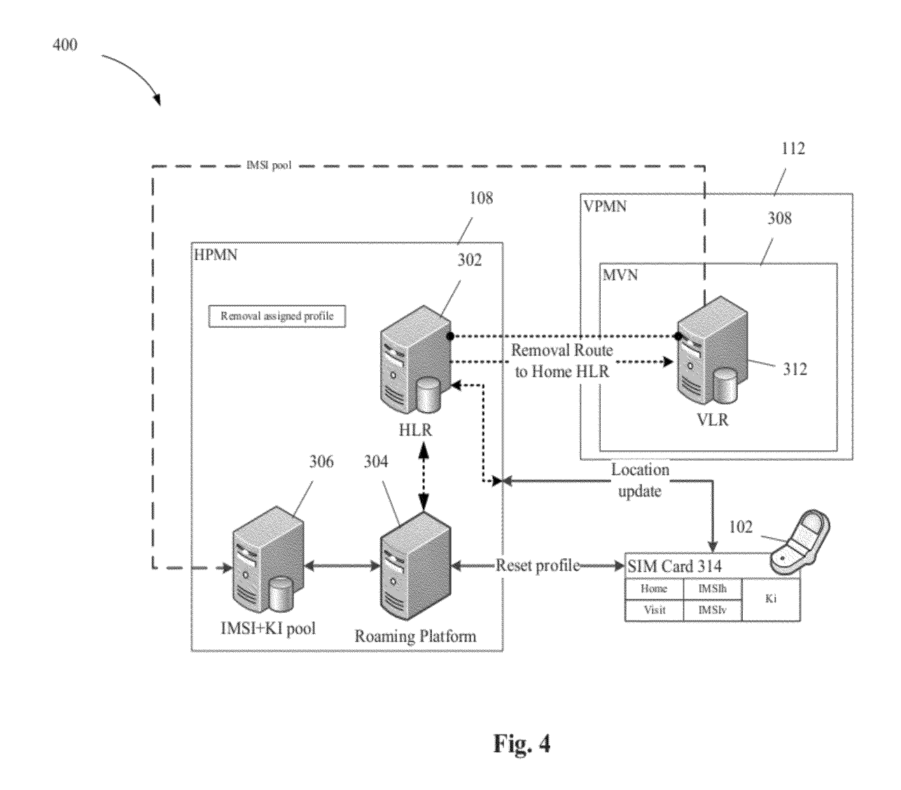

Turning now to FIG. 4, a block diagram showing the removal of a profile from a SIM card is illustrated. Roaming environment 400 contains HPMN 108 and VPMN 112. HPMN 108 contains HLR 302, Roaming platform 304 and IMSI+Ki pool 306. VPMN 112 contains MVN 308 and VLR 312. Also located in roaming environment 400 is mobile device 102. In this diagram, mobile device 102 was previously located in VPMN 112, but is no longer. When mobile device 102 was in VPMN 112, mobile device 102 had an identity profile in the form of a matching MSISDN and IMSI assigned to mobile device 102 by roaming platform 304 as described with regard to FIG. 3. Since the active profile was a profile that corresponded to VPMN 112, and since mobile device 102 is no longer located in VPMN 112, it is possible to remove the profile from SIM card 314 that is within mobile device 102.

In one aspect, when MVN 308 detects that mobile device 102 is no longer present, MVN 308 erases the profile from the VLR 312, and informs HLR 302 in the HPMN 108 that the mobile device is no longer present in VPMN 112. The HLR 302 removes the reference to the visited network's IMSI from the database maintained by HLR 302, and instructs the roaming platform 304 to send a command to mobile device 102 to remove or deactivate the identity profile that is associated with VPMN 112.

In another embodiment, mobile device 102 can initiate the removal of the profile by sending a request via SMS or USSD to roaming platform 304. Roaming platform 304 then instructs the HLR 302 to remove the reference to the visited network's IMSI in the database of matching MSISDN and IMSIs in order to update the database for the purpose of rerouting. The HLR 302 can then inform the VLR 312 that the visited network's IMSI profile for mobile device 102 is no longer active to remove the visited network's IMSI profile from the database maintained by HLR 302.

In yet another embodiment, HPMN 108 can perform a location update when HPMN 108 detects, or in response to detection of, the presence of mobile device 102 in its network. When the location is determined to be within HPMN 108, the HLR 302 removes the reference to the visited network's matching MSISDN and IMSI identities and instructs roaming platform 304 to remove or deactivate the visited network's profile on SIM card 314, since rerouting is no longer needed when the mobile device 102 is in the HPMN 108.

Turning now to FIG. 5, a block diagram of a system for making a mobile terminating call in accordance with an embodiment is illustrated. Shown is roaming environment 500 with Visited VoIP Gateway (VVG) 504, mobile device 516, and visited Mobile Switching Center (VMSC) 514 which are in a visited network (not shown). Home VoIP Gateway (HVG) 502, switching platform 506, and roaming platform 508 are within a home network (not shown). Connecting the two networks and managing communications between the networks are Mobile Virtual Network Operator 510 with associated Home Location Register 512.

Switching function 506 receives an Integrated Service Digital Network Initial Address Message (ISDN-IAM) that informs the switching function 506 that a call has been established on the Circuit Identification Code contained in the message. The ISDN-IAM contains the called and the calling number, type of service requested (speech or data) and other optional parameters. Switching function 506 forwards the ISDN-IAM to roaming platform 508 which then forwards the routing information with the number to be called to MVNO 510. MVNO 510 requests VMSC 514 to provide the roaming number for mobile device 516, which sends back a message containing the roaming number to MVNO 510. MVNO 510 forwards the roaming number to the roaming platform 806. Roaming platform 508 sends a Session Initiation Protocol (SIP) invitation to switching platform 506 which forwards the SIP invite to HVG 502. HVG 502 sends the SIP invite to VVG 504.

VVG 504 receives the SIP invite, requesting to start a VoIP session with HVG 502, and sends an ISDN-IAM to VMSC 514 with information regarding the called number, and calling party. The VMSC 514 sends a paging request to the mobile device 516 using the Temporary Mobile Subscriber Identity assigned by the VLR to every mobile in the area. Mobile device 516 sends a paging request acknowledgement back to VMSC 514, and the VMSC 514 establishes call control with mobile device 516 and informs the VVG 504 that the mobile device is ringing. VVG 504 sends the confirmation that mobile device 516 is ringing to HVG 502, which forwards the confirmation to switching platform 506. At this point, switching platform 506 transmits an Address Complete Message (ACM) to the calling party, informing the calling party that the called subscriber has been reached and the phone has begun ringing. The switching platform 506 also hands off the phone call to the HVG 502, for the duration of the call.

Charging Data Records (CDR) are created for billable events at various components in the system. A CDR is created for the interactions between the VMSC 514 and the mobile device 516. A CDR is created also at the VVG 504 and the HVG 502, as well as at the switching platform for its interactions with the calling party. Since each of the CDRs are created for local events, there are no long distance or roaming bills associated with this embodiment.

In an additional embodiment, the phone calls can be connected via the MVNO 510 and rerouted using the database stored in HLR 512. As the phone calls remain locally connected, using a local roaming number for the mobile device 516, roaming expenses are minimized.

Turning now to FIG. 6, a block diagram of a system for making a phone call that originates from a mobile device in accordance with an embodiment is illustrated. Shown is roaming environment 600 with Visited VoIP Gateway (VVG) 604, mobile device 616, and Visited Mobile Switching Center (VMSC) 614 which are in a visited network (not shown). Home VoIP Gateway (HVG) 602, switching platform 606, and roaming platform 608 are within a home network (not shown). Connecting the two networks and managing communications between the networks are Mobile Virtual Network Operator 610 with associated Home Location Register 612.

Mobile device 616 initiates call management service request sent to VMSC 614. VMSC 614 accepts the request, and sends a USSD request to MVNO 610 which forwards the USSD request to roaming platform 608. Roaming platform 608 returns the processed USSD request acknowledgment to the mobile device 616 via MVNO 610 and VMSC 614. Roaming platform 608 then requests the roaming number for mobile device 616 from MVNO 610 which obtains the number from VMSC 614. Roaming platform 608 then sends a session initiation protocol (SIP) invitation to switching platform 606 which forwards the SIP invitation to HVG 602. HVG 602 invites VVG 604 via the SIP invitation, and VVG 604 sends an Integrated Service Digital Network Initial Address Message (ISDN-IAM) message containing information regarding the called and calling party to the VMSC 614. VMSC 614 then establishes call control with mobile device 616 and processes the USSD request. VMSC 614 sends the USSD request acknowledgement to MVNO 610 which forwards it to roaming platform 608. VMSC 614 then hands over the call request to VVG 604 which sends a SIP invitation to HVG 602 which begins the VoIP connected call.

Charging Data Records (CDR) are created for billable events at various components in the system. A CDR is created for the interactions between the VMSC 614 and the mobile device 616. A CDR is created also at the VVG 604 and the HVG 602, as well as at the switching platform for its interactions with the calling party. Since each of the CDRs are created for local events, there are no long distance or roaming bills associated with this embodiment.

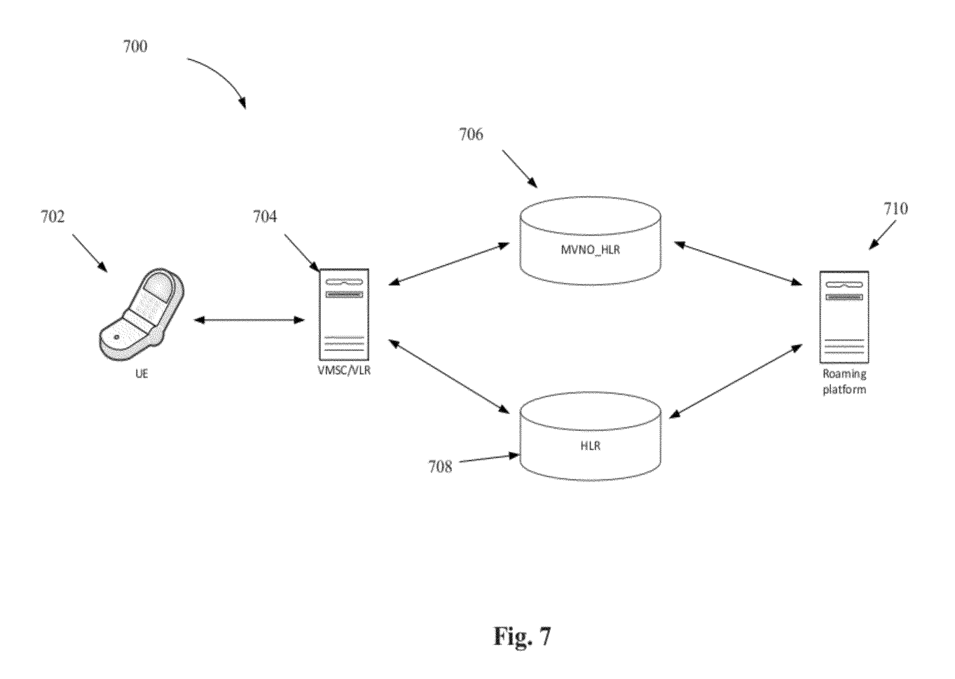

Turning now to FIG. 7, a block diagram showing a system for location updating of a mobile device is illustrated. Roaming environment 700 includes mobile device 702, VMSC 704, MVNO 706, HLR 708 and roaming platform 710.

In an aspect, location updating for an International Mobile Subscriber Identity (IMSI) that corresponds to an HPMN is initiated based on a signal sent from mobile device 702 to VMSC 704. VMSC 704 sends a Mobile Application Part (MAP) protocol message with routing information and an update location request to the HLR 708, which sends an acknowledgement of the location update request back to the VMSC 704. Mobile device 702 then sends a mobility management service request to the VMSC 704 that includes the previous location as well as the Temporary Mobile Subscriber Identity (TMSI) that was provided by the VMSC 704. The mobile device then sends a request to allocate a new user profile via an Unstructured Supplementary Service Data (USSD) protocol connection. VMSC 704 forwards the USSD request to the HLR 708, which forwards the request to the roaming platform 710. Roaming platform 710 assigns an MSISDN number to the MVNO 706 through the subscriber management interface.

The MVNO 706 confirms the MSISDN assignment and sends the confirmation back to the roaming platform 710. Roaming platform 710 sends the new MSISDN number to the HLR 708 via the USSD protocol, and the HLR 708 forwards the new identity to the VMSC 704 which forwards the identity to the mobile device 702.

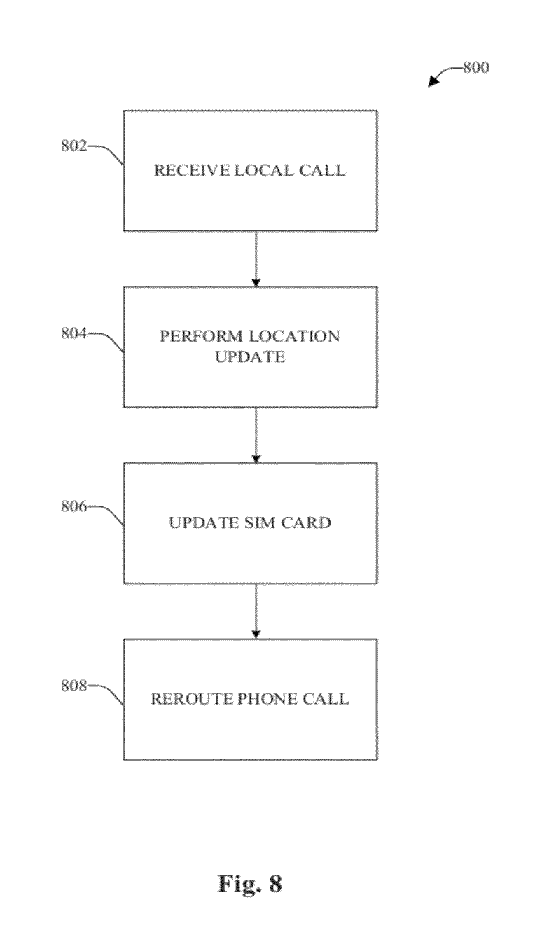

FIGS. 8-11 illustrate methodologies in accordance with the disclosed subject matter. For simplicity of explanation, the methodologies are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 8, process 800 associated with location updating and phone call rerouting for roaming mobile devices are illustrated in accordance with an embodiment. At step 802, network operator 106 receives a phone call placed by mobile device 104. The phone call is directed at mobile device 102 using the phone number mobile device 102 has associated with its profile on the first network 108. The first network forwards the incoming phone call to MVN 308. MVN 308 performs a location update at step 804 to determine the latest location of mobile device 102. MVN 308 transfers the location to HLR 302 which instructs roaming platform 304 to assign a new MSISDN and IMSI to SIM card 314 in mobile device 102. When the SIM card is updated at step 806, rerouting component 206 reroutes the phone call at step 808 to the new MSISDN number associated with mobile device 102.

In another aspect, at step 804, the location update can be initiated by mobile device 102 which establishes a USSD protocol link to VMSC 704. VMSC 704 then updates the location with MVNO 706 and HLR 708.

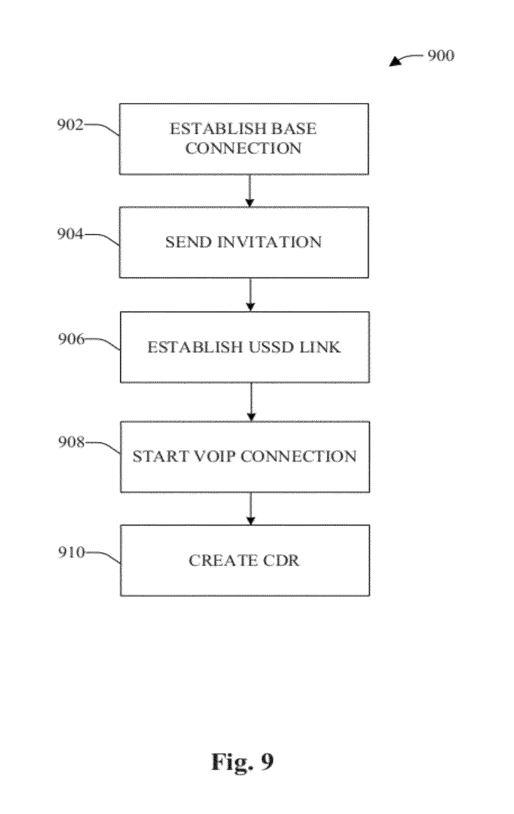

Referring now to FIG. 9, a flowchart diagram illustrating process 900 for making VoIP calls between mobile devices in a roaming environment is shown. At step 902 a connection is made between mobile device 616 and VMSC 614. Mobile device 616 sends a call management service request to VMSC 614 which forwards the request to roaming platform 608. VMSC 614 also sends a USSD request to MVNO 610 which forwards it to roaming platform 608. At step 904, an invitation is sent by the roaming platform for a session initiation protocol invitation to the switching platform which forwards to the invitation to the Home VoIP Gateway (HVG) 602. HVG 602 invites Visited VoIP Gateway (VVG) 604 via the SIP invitation, and VVG 604 sends an Integrated Service Digital Network Initial Address Message (ISDN-IAM) message containing information regarding the called and calling party to the VMSC 614. VMSC 614 then establishes call control with mobile device 616 and processes the USSD request at step 906. VMSC 614 then hands over the call request to VVG 604 which sends a SIP invitation to HVG 602 which begins the VoIP connected call at step 908.

Charging Data Records (CDR) are created at step 910 for billable events at various steps in the process. A CDR is created for the interactions between the VMSC 614 and the mobile device 616. A CDR is created also at the VVG 604 and the HVG 602, as well as at the switching platform for its interactions with the calling party. Since each of the CDRs are created for local events, there are no long distance or roaming bills associated with this embodiment.

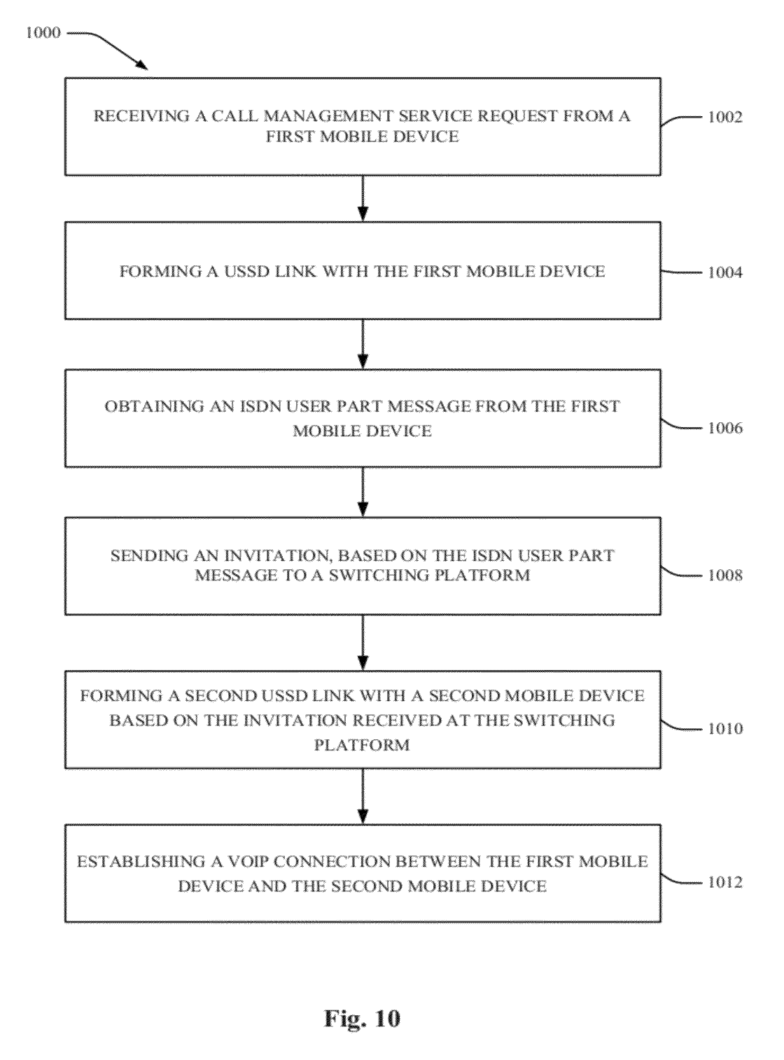

Turning now to FIG. 10, a flowchart process for a establishing VoIP calls between mobile devices is illustrated. At 1002, a request for call management service is received from a first mobile device. At 1004, an unstructured supplementary service data (USSD) protocol link is formed with the first mobile device allowing the mobile device to communicate with the service provider's computers in a real-time, two-way connection. Using the USSD link, an ISDN user part (ISUP) message, which is used to set up telephone calls is obtained from the first mobile device at step 1006. Based on the ISUP message obtained from the first mobile device, an invitation is sent to a switching platform at step 1008. At 1010 a second USSD link with a second mobile device is formed allowing real time, two-way communications with the second mobile device. The second USSD link is based on the invitation that specified the second mobile device's number that was received at the switching platform. At 1012, once USSD links were formed with the first and second mobile devices, a VoIP connection between the devices can be established.

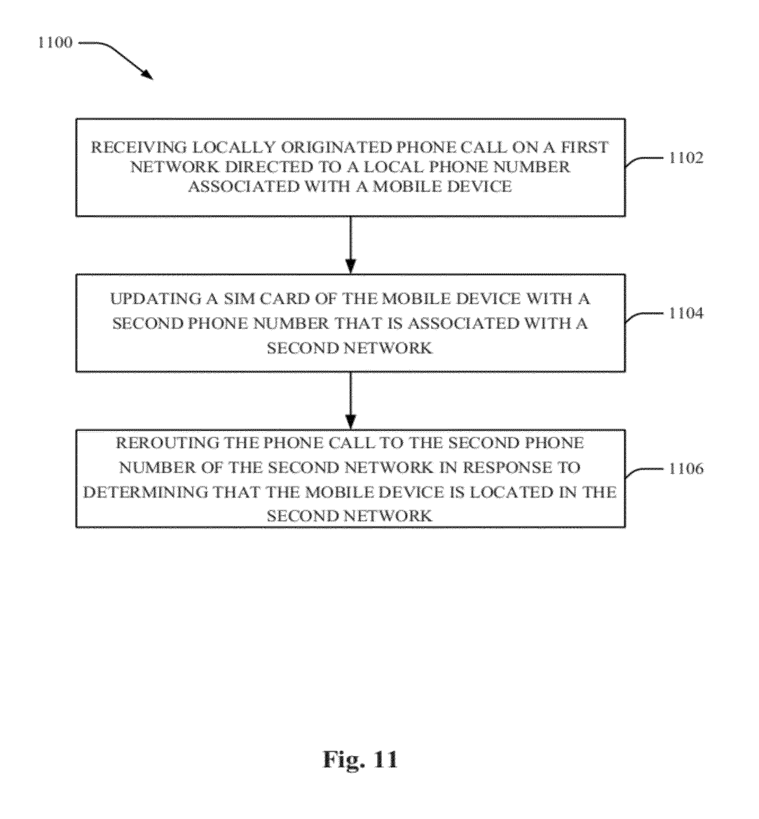

Referring now to FIG. 11, a flowchart process for rerouting a locally originated phone call to mobile device on a different network is illustrated. At 1102, a locally originated phone call on a first network is received that is directed towards a local phone number associated with a mobile device. At 1104, the SIM card of the mobile device the phone call was directed to is updated with a second phone number that is associated with a second network. At 1106, the locally originated phone call is rerouted to the second phone number is response to a determination that the mobile device is located on the second network.

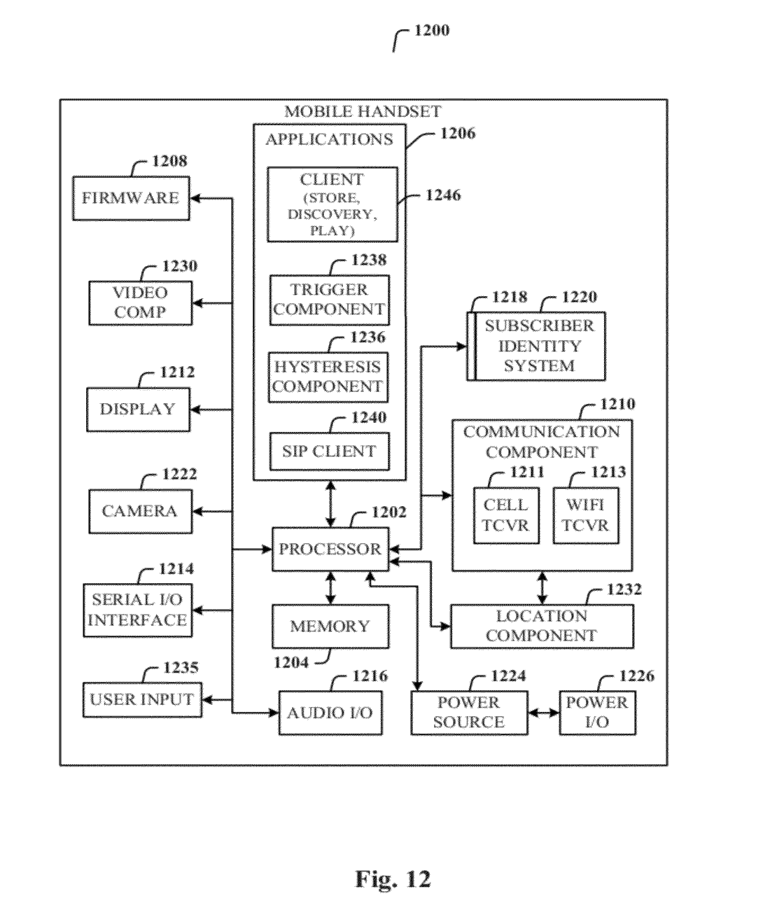

FIG. 12 illustrates a schematic block diagram of an exemplary device 1200 capable of employing the subject system in accordance with some embodiments of the invention. The device is a mobile handset 1200 In order to provide additional context for various aspects thereof, FIG. 12 and the following discussion are intended to provide a brief, general description of a suitable environment 1200 in which the various aspects can be implemented. While the description includes a general context of computer-executable instructions, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the inventive methods can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer-readable media. Computer readable media can be any available media that can be accessed by the computer and includes both volatile and non-volatile media, removable and non-removable media. By way of example and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1200 includes a processor 1202 for controlling and processing all onboard operations and functions. A memory 1204 interfaces to the processor 1202 for storage of data and one or more applications 1206 (e.g., a video player software, user feedback component software, . . . ). Other applications can include voice recognition of predetermined voice commands that facilitate initiation of the user feedback signals. The applications 1206 can be stored in the memory 1204 and/or in a firmware 1208, and executed by the processor 1202 from either or both the memory 1204 or/and the firmware 1208. The firmware 1208 can also store startup code for execution in initializing the handset 1200. A communications component 1210 interfaces to the processor 1202 to facilitate wired/wireless communication with external systems, e.g., cellular networks, VoIP networks, and so on. Here, the communications component 1210 can also include a suitable cellular transceiver 1211 (e.g., a GSM transceiver) and an unlicensed transceiver 1213 (e.g., WiFi, WiMax) for corresponding signal communications. The handset 1200 can be a device such as a cellular telephone, a PDA with mobile communications capabilities, and messaging-centric devices. The communications component 1210 also facilitates communications reception from terrestrial radio networks (e.g., broadcast), digital satellite radio networks, and Internet-based radio services networks.

The handset 1200 includes a display 1212 for displaying text, images, video, telephony functions (e.g., a Caller ID function), setup functions, and for user input. The display 1212 can also accommodate the presentation of multimedia content (e.g., music metadata, messages, wallpaper, graphics, . . . ). A serial I/O interface 1214 is provided in communication with the processor 1202 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1200, for example. Audio capabilities are provided with an audio I/O component 1216, which can include a speaker for the output of audio signals related to, for example, indication that the user pressed the proper key or key combination to initiate the user feedback signal. The audio I/O component 1216 also facilitates the input of audio signals through a microphone to record data and/or telephony voice data, and for inputting voice signals for telephone conversations.

The handset 1200 can include a slot interface 1218 for accommodating a SIC (Subscriber Identity Component) in the form factor of a card Subscriber Identity Module (SIM) or universal SIM 1220, and interfacing the SIM card 1220 with the processor 1202. However, it is to be appreciated that the SIM card 1220 can be manufactured into the handset 1200, and updated by downloading data and software thereinto.

The handset 1200 can process IP data traffic through the communication component 1210 to accommodate IP traffic from an IP network such as, for example, the Internet, a corporate intranet, a home network, a person area network, etc., through an ISP or broadband cable provider. Thus, VoIP traffic can be utilized by the handset 1200 and IP-based multimedia content can be received in either an encoded or decoded format.

A video processing component 1222 (e.g., a camera) can be provided for decoding encoded multimedia content. The handset 1200 also includes a power source 1224 in the form of batteries and/or an AC power subsystem, which power source 1224 can interface to an external power system or charging equipment (not shown) by a power I/O component 1226.

The handset 1200 can also include a video component 1230 for processing video content received and, for recording and transmitting video content. A location tracking component 1232 facilitates geographically locating the handset 1200. As described hereinabove, this can occur when the user initiates the feedback signal automatically or manually. A user input component 1234 facilitates the user initiating the quality feedback signal. The input component can include such conventional input device technologies such as a keypad, keyboard, mouse, stylus pen, and touch screen, for example.

Referring again to the applications 1206, a hysteresis component 1236 facilitates the analysis and processing of hysteresis data, which is utilized to determine when to associate with the access point. A software trigger component 1238 can be provided that facilitates triggering of the hysteresis component 1238 when the WiFi transceiver 1213 detects the beacon of the access point. A SIP client 1240 enables the handset 1200 to support SIP protocols and register the subscriber with the SIP registrar server. The applications 1206 can also include a client 1242 that provides at least the capability of discovery, play and store of multimedia content, for example, music.

The handset 1200, as indicated above related to the communications component 1210, includes an indoor network radio transceiver 1213 (e.g., WiFi transceiver). This function supports the indoor radio link, such as IEEE 802.11, for the dual-mode GSM handset 1200. The handset 1200 can accommodate at least satellite radio services through a handset that can combine wireless voice and digital radio chipsets into a single handheld device.

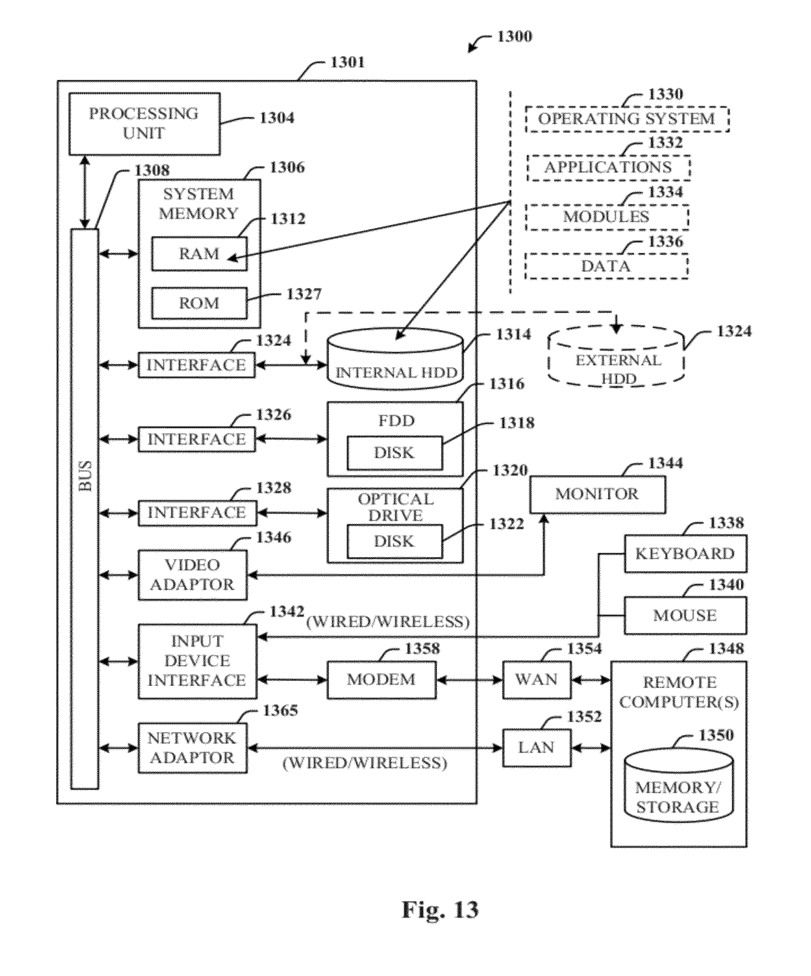

Referring now to FIG. 13, there is illustrated a block diagram of a computer operable to provide networking and communication capabilities between a wired or wireless communication network and a server and/or communication device. In order to provide additional context for various aspects thereof, FIG. 13 and the following discussion are intended to provide a brief, general description of a suitable computing environment 1300 in which the various aspects of the innovation can be implemented. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the exemplary environment 1300 for implementing various aspects includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 can also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1311 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is to be appreciated that the innovation can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 2394 serial port, a game port, a USB port, an IR interface, etc.

A monitor 1344 or other type of display device is also connected to the system bus 1308 through an interface, such as a video adapter 1346. In addition to the monitor 1344, a computer typically includes other peripheral output devices (not shown), such as speakers, printers, etc.

The computer 1302 can operate in a networked environment using logical connections by wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adaptor 1356 may facilitate wired or wireless communication to the LAN 1352, which may also include a wireless access point disposed thereon for communicating with the wireless adaptor 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 through the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE 802.11(a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A rerouting system in a wireless communications network, comprising:
a platform component configured to receive an incoming phone call from a first network to a mobile device based on a first phone number associated with the first network;
a data storage component configured to store a set of phone numbers associated with the mobile device; and
a rerouting component configured to redirect the incoming phone call based on the first phone number to a second phone number associated with a second network different from the first network, wherein the first phone number and the second phone number are associated with the mobile device.

2. The system of claim 1, further comprising a voice over IP (“VoIP”) component configured to connect the incoming phone call to the mobile phone over VoIP communications.

3. The system of claim 1, wherein the mobile phone includes a subscriber identity module (“SIM”) card including the first phone number corresponding to a first identity of the mobile device on the first network, and the second phone number corresponding to a second identity of the mobile device on the second network.

4. The system of claim 3, wherein the first phone number and the second phone number are mobile subscriber integrated service digital network (“MSISDN”) numbers and the first identity and the second identity are individual mobile subscriber identities (“IMSIs”).

5. The system of claim 3, wherein the SIM card is pre-provisioned with the first identity and the second identity.

6. The system of claim 3, wherein the platform component is further configured to assign a new IMSI and MSISDN to the SIM card in response to the mobile device being activated in the second network.

7. The system of claim 6, further comprising:
an over the air component configured to receive a profile change request from the mobile device; and
a roaming platform component configured to determine a location of the mobile device and assign a new IMSI and a new MSISDN to the mobile device based on the location of the mobile device.

8. The system of claim 7, wherein the roaming platform component is further configured to determine the location of the mobile device based on a mobile switching component in the second network.

9. A method for rerouting phone calls in a wireless communication network, the method comprising:
receiving a phone call locally originated on a first network directed to a local phone number associated with a mobile device;
updating a subscriber identity module (“SIM”) card of the mobile device with a second phone number that is associated with a second network; and
in response to determining the mobile device is located in the second network, rerouting the phone call to the second phone number of the second network.

10. The method of claim 9, wherein the updating the SIM card further comprises:
selecting a mobile subscriber integrated service digital network (“MSISDN”) number and an individual mobile subscriber identity (“IMSI”) based on an updating of the location of the mobile device; and
downloading the MSISDN number and IMSI from a roaming platform component.

11. The method of claim 9, wherein the updating of the location of the mobile device further comprises obtaining the location from a mobile switching component in the second network.

12. The method of claim 11, wherein the obtaining the location from a mobile switching component includes querying the mobile device with an unstructured supplementary service data call.

13. A system for managing mobile device profiles, comprising:
a data store that maintains a pool of identity profiles, wherein the identity profiles correspond to distinct networks;
a home location register (“HLR”) that obtains a location of a mobile device from a visited location register (“VLR”) of a network within range of which the mobile device is located; and
a roaming platform that assigns the mobile device an identity profile that corresponds to the network within range of which the mobile device is located based on the location obtained by the HLR.

14. The system of claim 13, wherein the identity profiles comprise a mobile subscriber integrated service digital network (“MSISDN”) and individual mobile subscriber identity (“IMSI”) pair.

15. The system of claim 13, wherein the roaming platform receives a profile change request from the mobile device and the roaming platform instructs the HLR to retrieve the location from the VLR.

16. The system of claim 15, wherein the profile change request is sent over at least one of a short message service protocol or an unstructured supplementary service data protocol.

17. The system of claim 13, further comprising a visited mobile switching center that sends an indication to the roaming platform in response to the location of the mobile device being out of range of the network.

18. The system of claim 13, wherein the roaming platform sends a signal to the mobile device to remove the identity profile corresponding to the network.

19. A method for making voice over IP (“VoIP”) calls for roaming mobile devices, comprising:
receiving a call management service request from a first mobile device;
forming an unstructured supplementary service data (“USSD”) link with the first mobile device;
obtaining an integrated service digital network (“ISDN”) user part message from the first mobile device;
sending an invitation, based on the ISDN user part message, to a switching platform;
forming a second USSD link with a second mobile device based on the invitation received at the switching platform; and
establishing a VoIP connection between the first mobile device and the second mobile device.

20. The method of claim 19, wherein the establishing the VoIP connection further comprises:
sending an invitation from the switching platform to a first VoIP gateway; and
forwarding the connection from the first VoIP gateway to a second VoIP gateway, wherein the first VoIP gateway is linked with the second mobile device, and the second VoIP gateway is linked with the first mobile device.

21. The method of claim 19, wherein the forming the second USSD link with the second mobile device comprises transmitting a call management service request to the second mobile device.

22. The method of claim 19, further comprising billing the first mobile device and the second mobile device for local phone calls only.

23. A system, comprising:
means for receiving a call request via a visited mobile switching center of a visited network;
means for identifying information about the call request;
means for forwarding the call request to a roaming platform on a home network based on the information;
means for establishing a voice over IP (“VoIP”) connection between a home VoIP gateway and a visited VoIP gateway in response to the call request.

24. The system of claim 23, wherein the means for establishing the VoIP connection between the home VoIP gateway and the visited VoIP gateway comprises a means for sending a session initiation protocol invitation.

25. A computer readable storage medium comprising computer executable instructions that, in response to execution by a computing system, cause the computing system to perform operations, comprising:
receiving a call request via a visited mobile switching center of a visited network;
identifying information about the call request;
forwarding the call request to a roaming platform on a home network based on the information; and
establishing a voice over IP (“VoIP”) connection between a home VoIP gateway and a visited VoIP gateway in response to the call request.
